(19) United States
(12) Patent Application Publication
(10) Pub. No.: US 2006/0236050 A1
(43) Pub. Date: Oct. 19, 2006

(54) Computer system, computer, and remote copy processing method

(75) Inventors: Sadahiro Sugimoto, Yokohama (JP); Kazuyoshi Serizawa, Tama (JP); Yoshiaki Eguchi, Yokohama (JP); Takashige Iwamura, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/187,454

(22) Filed: Jul. 22, 2005

(30) Foreign Application Priority Data
Apr. 5, 2005 (JP) 2005-108778

(51) Int. Cl. G06F 12/00

(52) U.S. Cl. 711/162

(57) ABSTRACT

Both of continuation of a job and response to a system failure caused by a disaster are realized simultaneously at low costs.

When a failure in remote copy is reported from storage 103A, host 102A starts the host-based remote copy. At this time, first the remote copy is performed starting from the copy to an unfinished I/O. when it becomes possible to restart the storage-based remote copy, the host 102A first stops issuing an I/O and waits for completion of an outstanding I/O in accordance with a command from management server 104A. Thereafter, the host 102A switches over a remote copy method and restarts the I/O.

### CROSS-REFERENCE TO RELATED APPLICATION(S)

The present application claims priority from Japanese application JP2005-108778 filed on Apr. 5, 2005, the content of which is hereby incorporated by reference into this application.

### BACKGROUND OF THE INVENTION

The present invention relates to a computer system, a computer, and a remote copy processing method, wherein data is replicated and stored in a plurality of storage apparatuses in an information processing system in which a plurality of storage apparatuses (hereinafter, described as a storage) and host computers (hereinafter, described as a host) are connected through a network.

In an information processing system, especially a so-called mission critical system such as a financial system in which neither a loss of data nor suspension of service is permitted, there are not a few cases in which a backup system is set up at a remote place in order to be prepared for a system failure caused by a disaster. In those cases, a technology of remote copy for replicating and storing data in storages is necessary.

The remote copy means the technology in which a storage automatically executes copying data on a volume of a storage at a copy destination when a host writes the data into a volume of a certain predetermined storage at a copy source.

A host-based remote copy in which a host replicates data and a storage-based remote copy in which a storage replicates data are known as methods of realizing the remote copy. In the storage-based remote copy, there is such an advantage that a load of data replication is not imposed on a host (refer to the patent reference 1).

Moreover, even in the storage-based remote copy, the remote copy is performed by using an FC (Fibre Channel) network connecting between storages, and also hosts mutually monitor each other's state through an IP (Internet Protocol) network connecting between the hosts (refer to the patent reference 2).

[Patent reference 1] U.S. Pat. No. 5,155,845

[Patent reference 2] Published Japanese Patent Application No. 2004-302512.

In the above-described mission critical system, it is not permitted to suspend a job even if a communication failure would occur in a path of the remote copy. Accordingly, although data is left on a volume of a storage at a copy source by making a job executed in a state where the remote copy is not possible, this data can not be reflected on a volume of a storage at a copy destination.

However, when the job is continued while the remote copy is suspended, the data is written only on the volume of the storage at the copy source, but response to a system failure caused by a disaster, which is required for the mission critical system, is not possible in the state where this data is not reflected on this volume of the storage at the copy destination.

Accordingly, a method of making a system prepared for a communication failure by multiplexing a remote copy path in anticipation of such a system failure can be considered, but there is such a problem that costs increase by just that much when the number of paths are made plural. Especially, it is generally practiced to connect between storages by using a lease line in storage-based remote copy, but costs for multiplexing this lease line are very expensive.

### BRIEF SUMMARY OF THE INVENTION

The present invention aims at solving the above-described problem and realizing simultaneously both of continuation of a job and response to a system failure caused by a disaster at low costs.

In order to solve the above-described problem and achieve the objective of the present invention, a computer system of the present invention is configured to have a first remote copy function portion which is provided in a first storage apparatus or second storage apparatus in order to perform a first remote copy in which contents of a first logical volume and contents of a second logical volume are made to match by mutually performing communication between the first storage apparatus and the second storage apparatus, and a second remote copy function portion which is provided in a first host computer or second host computer in order to perform a second remote copy in which the contents of the first logical volume and the contents of the second logical volume are made to match by mutually performing communication between the first host computer and the second host computer.

Furthermore, the computer system of the present invention is configured to have a first remote copy suspension detection function portion which is provided in the first host computer or second host computer in order for the first host computer or second host computer to detect suspension of the first remote copy based on information from the first remote copy function portion, and a second remote copy switchover function portion which is provided in the first host computer or second host computer for switching over to the second remote copy performed by the second remote copy function portion and activating the second remote copy when the first host computer or second host computer detects that the first remote copy performed by the above-described first remote copy function portion is suspended.

According to the present invention, the first storage-based remote copy is performed at normal time by the first remote copy function portion, and when it is detected by the first remote copy suspension detection function portion that a failure has occurred in the communication between the storages, the second remote copy switchover function portion switches over to the second host-banded remote copy performed by the second remote copy function portion. When the communication between the storages is restored after the switchover to the second remote copy, the switchover is performed again to the first storage-based remote copy.

According to the present invention, both of continuation of a job and response to a system failure caused by a disaster can be realized simultaneously by switching over to the second host-based remote copy so that the second remote copy is used at the time of failure in the first storage-based remote copy while the first storage-based remote copy is used at normal time in order to reduce a load on a host.

In addition, since a communication line between storages is not multiplexed but a communication line between hosts is used as a substitution, it is possible to keep costs low.

### BRIEF DESCRIPTION OF THE DRAWINGS

FIG. 1 is a diagram showing an overall configuration of a computer system according to the present invention;

FIG. 2 is a diagram showing a relation among components of the computer system;

FIG. 3 is a flow chart showing a processing procedure of a remote copy program of a host;

FIG. 4 is a flow chart showing a procedure of I/O processing in the processing procedure of the remote copy program;

FIG. 5 is a flow chart showing a procedure of starting a host-based remote copy in the processing procedure of the remote copy program;

FIG. 6 is a diagram showing a procedure of restarting a storage-based remote copy;

FIG. 7 is a diagram illustrating an outline of remote copy processing at normal time;

FIG. 8 is a diagram illustrating an outline of processing at the time of failure in the storage-based remote copy;

FIG. 9 is a diagram illustrating an outline of processing for restarting the storage-based remote copy; and

FIG. 10 is a flow chart showing a processing procedure of another remote copy program.

### DESCRIPTION OF THE PREFERRED EMBODIMENTS

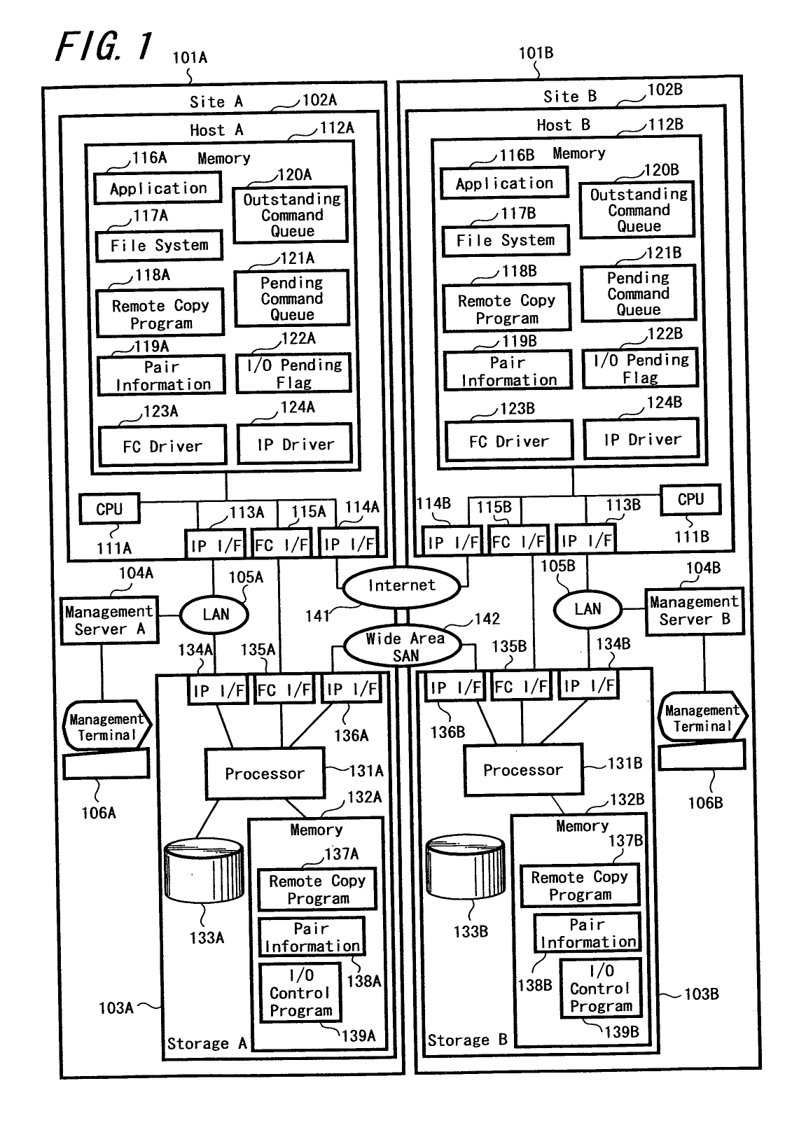

FIG. 1 is a configuration diagram of the whole system in the present embodiment.

A site A 101A is a site where a normal job is performed, and a site B 101B is a backup site located at a place far from the site A 101A.

Each site 101 (101A and 101B) has a host 102, a storage 103, and a management server 104. These three apparatuses are connected with a LAN 105, and are able to communicate mutually. The management server 104 performs a setting change and status monitoring of the host 102 and the storage 103. In addition, a management terminal 106 is a computer for a system administrator to perform an operation such as the above-described setting change from this management terminal 106, and is directly connected with the management server 104 so that communication can be performed mutually. The management terminal 106 may be connected with the management server 104 through the LAN 105.

Each host 102 is provided with at least a CPU 111, a memory 112, an IP I/F 113, an IP I/F 114, and an FC I/F 115.

The memory 112 stores programs and data that are processed by the CPU 111, more specifically stores an application 116, a file system 117, a remote copy program 118, pair information 121, an outstanding command queue 120, a pending command queue 121, an I/O pending flag 122, an FC driver 123, and an IP driver 124.

The application 116 is a program relating to processing of a job such as data base management software. The file system 117 is a program in which an I/O to a file generated when the CPU 111 performs processing of the application 116 is converted into an I/O to the remote copy program. The remote copy program 118 is a program relating to processing of the remote copy. Details of the remote copy program 118 are described later. The pair information 119, the outstanding command queue 120, the pending command queue 121, and the I/O pending flag 122 are data handled by the remote copy program 118.

The FC driver 123 is a program that controls the FC I/F 115, and the IP driver 124 is a program that controls the IP I/Fs 113 and 114.

The IP I/F 113 is an interface to perform communication with the management server 104 and the storage 103. Although it is described in the present embodiment that the IP I/F 113 performs the communication based on the IP (Internet Protocol), an interface that conforms to another standard may be applied. Also, the IP I/F 114 is an interface to perform communication with the host 102, and similarly to the IP I/F 113 an interface that conforms to another standard may be applied. Here, it is also possible to share the IP I/Fs 113 and 114.

The FC I/F 115 is an interface to perform an input and output of data to each storage (103A or 103B). More precisely, the FC I/F 115 is an HBA (Host Bus Adaptor) of FC (Fibre Channel), but an interface that conforms to another standard such as SCSI, iSCSI, and the like may be applied.

Each storage (103A or 103B) is provided with a processor 131, a memory 132, a volume 133, an IP I/F 134, an FC I/F 135, and an FC I/F 136.

Each memory (132A or 132B) holds a remote copy program 137, pair information 138, and an I/O control program 139 which are processed by the processor 131. An explanation of the programs is described later.

The IP I/F 113A of the host 102A and the IP I/F 113B of the host 102B perform communication through an internet (Internet) 141. It should be noted that this 141 may be a communication line other than the internet (Internet). The internet (Internet) 141 is used at least for communication to perform the host-based remote copy in the present embodiment.

The FC I/F 136A of the storage 103A and the FC I/F 136B of the storage 103B perform communication through a wide area SAN (Storage Area Network) 142. It should be noted that this 142 may be a communication line other than the wide area SAN. In the present embodiment, the wide area SAN 142 is used at least for communication to perform the storage-based remote copy.

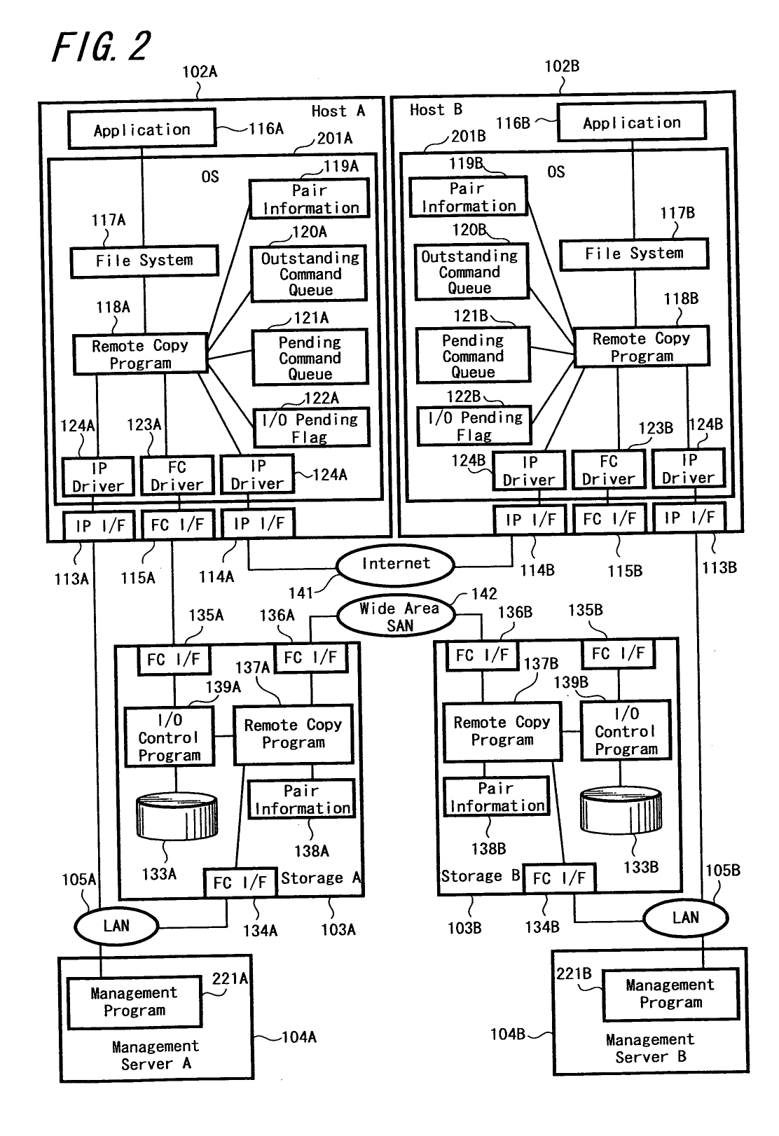

FIG. 2 is a diagram showing a relation among components in the embodiment of the present invention.

In the present embodiment, various processing is performed not only by mutual cooperation between the remote copy programs of the hosts and mutual cooperation between the remote copy programs of the storages but also by cooperation between the remote copy program of the host and both of the remote copy program and I/O control program of the storage in order to realize guarantee of data consistency at the time of switching over remote copy method.

The CPU 111A creates an I/O to the storage 103A by executing the remote copy program 118A based on an I/O that is created by using the file system 117A. In addition, contents of the primary volume 133A in the storage 103A and contents of the secondary volume 133B in the storage 103B are made to match by transmitting this I/O to the host B during the suspension of remote copy in the storages 103A and 103B. The CPU 111A controls the FC I/F 115A by executing the FC driver 123A, and transmits the I/O to the storage 103A. In addition, the CPU 111A controls the IP I/F 114A by executing the IP driver 124A, and issues the I/O to the host B.

The CPU 111A that executes the remote copy program 118A also changes the pair information 119A in accordance with a request from a management program 221A and a result of the I/O reported from the storage 103A. In the pair information 119A, an I/O issuing destination (primary volume identifier, host 102B identifier, and secondary volume identifier) and a pair state are stored as information on the primary volume 133A and secondary volume 133B of the remote copy. At least two kinds of state that are a synchronized state (PAIR: a state where writing from the host 102A to the primary volume 133A is copied on the secondary volume 133B) and a suspended state due to an error (PSUE: a state where the relevant pair is not synchronized due to an error) are defined as the pair state.

The outstanding command queue 120A is a queue to keep memorizing a command which the host 102A has issued but to which a completion report has not been returned yet from the storage 103A. The pending command queue 121A is a queue for holding contents of request thereof when an I/O is made pending. The I/O pending flag 122A is a flag to show that the I/O is pending when the flag is ON and the I/O is not pending when the flag is OFF. These queue and flag are used in order to guarantee data consistency at the time of switching over the remote copy method.

The host 102B relays the I/O from the host 102A to the storage 103B based on the remote copy program 118B. More specifically, the host 102B receives the I/O from the host 102A, and sends the contents thereof to the storage 103B. Further, a result of the I/O to the storage 103B is sent to the host 102A. In addition, the pair information 119B is changed in accordance with a request from the host 102A.

In the storage 103A, the processor 131A writes a write I/O received from the host 102A into the volume 133A based on the I/O control program 139A, and at the same time, transfers to the storage 103B by executing the remote copy program 137A. In case of a read I/O, remote copy processing is not necessary, and the processor 131A sends the contents of the volume 133A to the host 102A. In addition, the processor 131A that executes the remote copy program 137A changes the pair information 138A based on a command from the management server 104A and also on a success or failure of the remote copy processing.

As the information on the primary volume 133A and secondary volume 133B of the remote copy, the primary volume identifier, the secondary volume identifier, and the pair state are stored in the pair information 138A. The information with respect to the pair state is similar to the pair information 119A on the host.

Here, it is necessary that both of the host-based remote copy and the storage-based remote copy can be performed to one pair of volumes as the specific feature of the present invention, and for this purpose the same setting information as to one pair of volumes is made to be included in both of the pair information 119 stored on the host and the pair information 138 stored on the storage.

In the storage 103B, the processor 131B receives the I/O from the storage 103A based on the remote copy program, and reflects this I/O on the volume 133B based on the I/O control program 139B. In addition, the processor 131B that executes the remote copy program 137B changes the pair information 138B based on a command from the management server 104B and also on a success or failure of the remote copy processing.

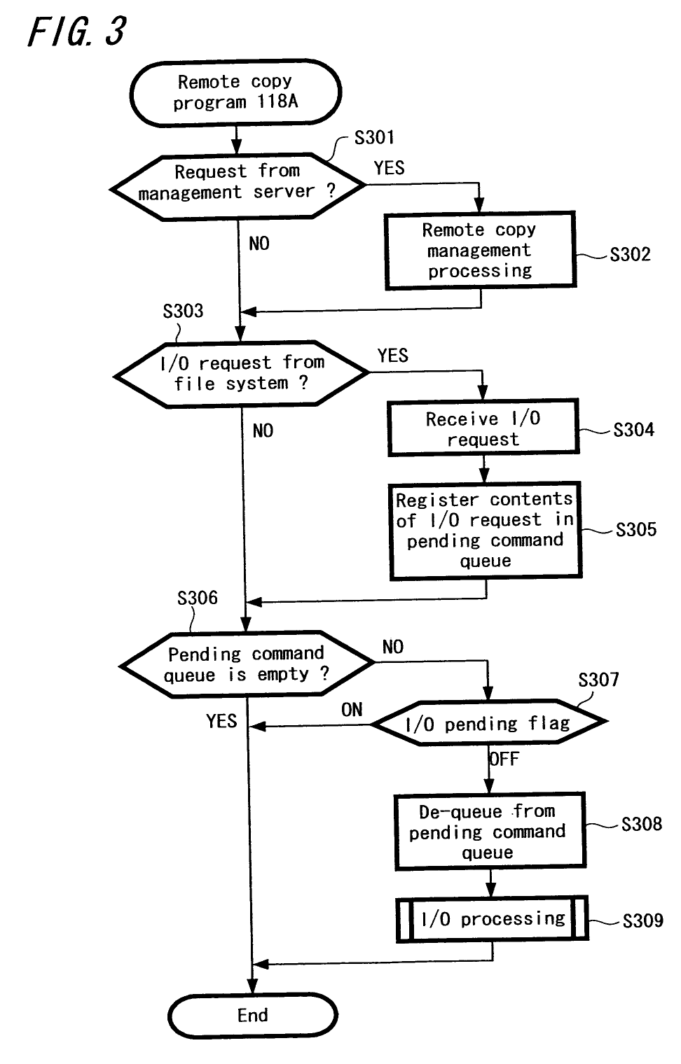

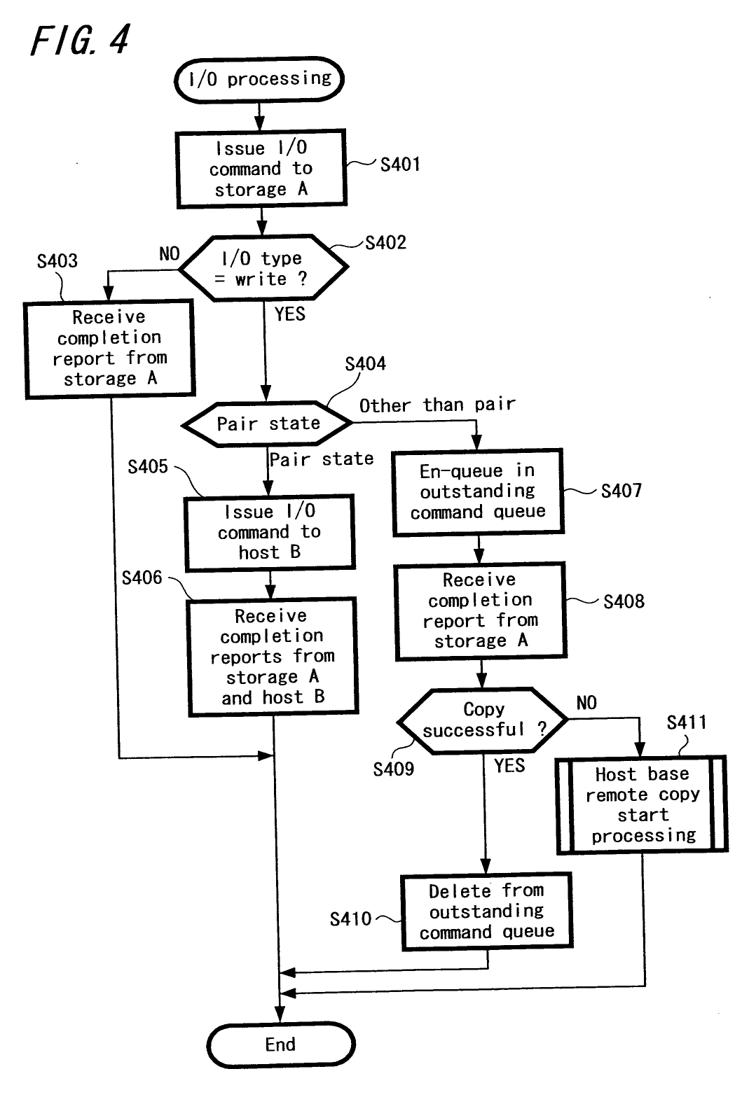

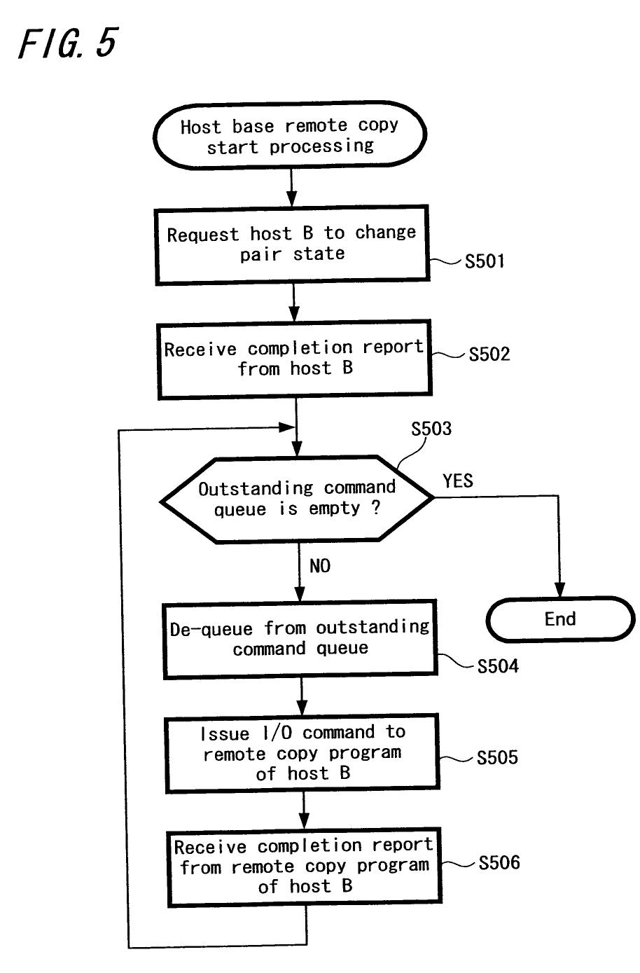

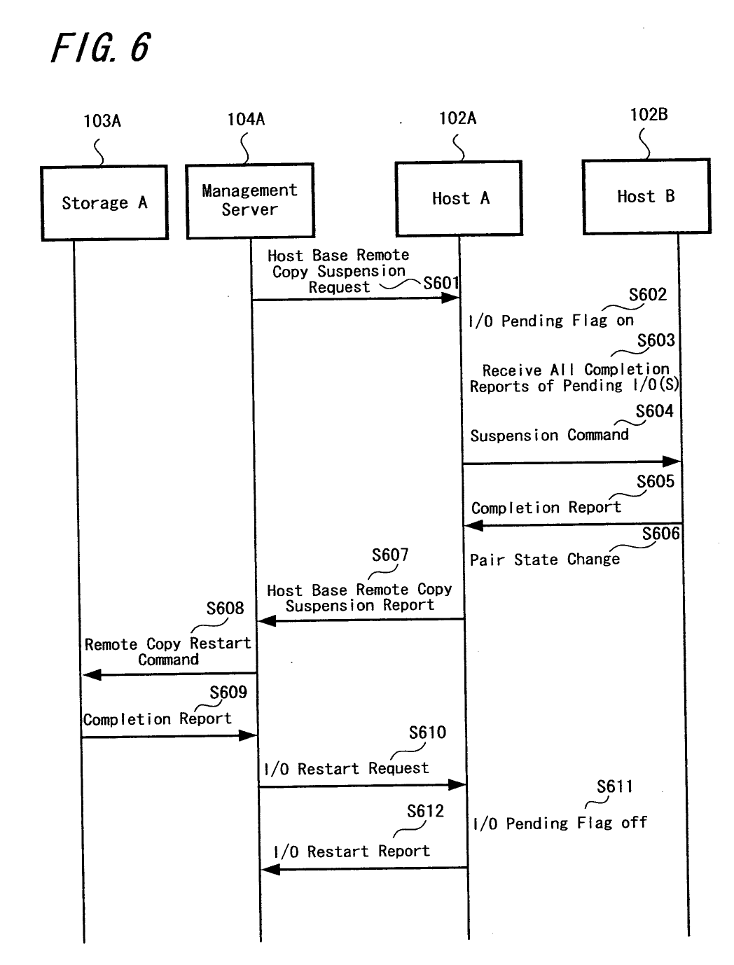

Next, a processing procedure of the remote copy program 118A that is executed by the CPU 111A is explained by using flow charts of FIG. 3, FIG. 4, FIG. 5, and FIG. 6.

FIG. 3 is a flow chart showing a processing procedure of the remote copy program 118A as a whole in the host 102A.

First, the CPU 111A checks whether there is a request from the management server 104 (step S301), and performs remote copy management processing if there is the request (step S302). As the remote copy management processing, the CPU 111A performs one of processing for changing a pair state of the pair information 119A, processing for reporting the pair state, processing for changing the I/O pending flag 122A, and processing for waiting for a completion of the outstanding I/O in accordance with a command from the management server 104A. Next, the CPU 111A checks if there is an I/O from the file system 117A (step S303), receives a request if there is the request (step S304), and registers contents thereof to the pending command queue 121A (step S305). In this case, the pending command queue 121A is used to save a command in normal processing.

Thereafter, the CPU 111A checks whether the pending command queue 121A is empty (step S306), and the process ends without performing any further processing if the pending command queue 121A is empty. If the pending command queue 121A is not empty, the CPU 111A checks the I/O pending flag 122A (step S307), and the process ends without performing any further processing if the I/O pending flag 122A is ON. If the I/O pending flag 122A is OFF, the CPU 111A takes out (de-queue) the contents of the I/O in the order of entry from the pending command queue 121A (step S308), and performs I/O processing (step S309).

As shown in the processing from step S303 that is the checking of the I/O request from the file system 117A to step S309 that is the I/O processing, the CPU 111A only saves the I/O in the pending command queue 121A and does not perform the I/O processing when the I/O pending flag 122A is in a state showing that the I/O is pending. By this procedure, it becomes possible to make the I/O pending, which is necessary in order to prevent a reversal in the order of writing and an omission of writing, at the time of switchover from the host-based remote copy to the storage-based remote copy, which is described later.

FIG. 4 is a flow chart of the I/O processing which is shown in step S309 of FIG. 3.

First, the CPU 111A issues an I/O to the storage 103A (step S401). Thereafter, the CPU 111A checks an I/O type (step S402), receives a completion report from the storage 103A if the I/O type is not a write I/O (step S403), and ends the process. If the I/O type is the write I/O, the CPU 111A checks a pair state (step S404). When the pair state is a synchronized state, more specifically a state in which the host-based remote copy should be performed, the CPU 111A issues an I/O to the host 102B (step S405), receives completion reports from both the storage 103A and the host 102B (step S406), and ends the process.

If the pair state is a state other than the synchronized state, more specifically a suspended state due to an error in which the host-based remote copy is not performed, first the CPU 111A enters (en-queue) contents of the I/O in the outstanding command queue 120A (step S407), and receives a completion report from the storage 103A (step S408). Next, the CPU 111A checks this completion report (step S409), deletes the relevant command from the outstanding command queue 120A if the copy is successful (step S410), and ends the process. In case that the copy is failed, the CPU 111A performs processing for starting the host-based remote copy (step S411). In this case, the processing for starting the host-based remote copy is executed immediately when the switchover is made from the storage-based remote copy to the host-based remote copy.

As shown in the processing of step S408 that is the completion report from the storage A, step S409 that is the judgment whether the copy is successful, and step S411 that is the processing for starting the host-based remote copy, the host-based remote copy is started when the report of the failed remote copy is received from the storage. Thereby, it is possible to continue the remote copy even when a failure occurs in the storage-based remote copy. However, although details are described later, contents of an I/O showing a command of I/O processing which has not been finished yet (the host 102A has not received a response of having completed the remote copy from the storage 103A although the host 102A has issued the I/O) becomes necessary for guarantee of data consistency in this processing of starting the host-based remote copy. For this purpose, the contents of the I/O are stored in the outstanding command queue 120A at step S407, and are retained until the I/O is completed.

FIG. 5 is a flow chart of the processing for starting the host-based remote copy.

First, the CPU 111A requests a change of the pair state to the host 102B (step S501), and receives a completion report (step S502). Next, the CPU 111A checks whether the outstanding command queue 120A is empty (step S503), and ends the process if the outstanding command queue 120A is empty. If the outstanding command queue 120A is not empty, the CPU 111A performs processing of the command stored in the outstanding command queue 120A sequentially until the outstanding command queue 120A becomes empty. More precisely, the CPU 111A de-queues the contents of the I/O from the outstanding command queue 120A (step S504), sends the contents to the host 102B (step S505), and receives a completion report from the host 102B (step S506). Further, the CPU 111A returns to step S503, and checks whether the outstanding command queue 120A becomes empty (step S503).

As shown in the processing from step S503 that is the checking whether the outstanding command queue 120A is empty to step S506 that is the completion report from the host 102B, it becomes possible for the host 102A to write the data written in the storage 103A also in the storage 103B without omission by first performing the copy to the unfinished I/O at the time of starting the remote copy.

FIG. 6 illustrates a flow in which the processing of the storage-based remote copy is restarted by switchover processing from the host-based remote copy to the storage-based remote copy.

First, the management server 104A sends a request for suspension of the host-based remote copy to the host 102A in accordance with a system administrator's operation (step S601). In this case, a command of host-based remote copy suspension from the management server 104A is issued at system administrator's timing when the storage-based remote copy is restarted.

The host 102A having received this request starts making an I/O pending by turning the I/O pending flag 122A into ON (step S602). A procedure of making the I/O pending is as shown in the steps from step S303 to step S307 in FIG. 3. When the host 102A receives all completion reports to I/Os which have been issued before making the I/O pending (step S603), the host 102A sends the suspension command to the host 102B (step S604). When a suspension completion report is returned from the host 102B (step S605), the host 102A changes the pair state to a suspended state (step S606), and reports the suspension of the host-based remote copy to the management server 104A (step S607). The management server 104A having received this report sends a command of restarting the storage-based remote copy to the storage 103A (step S608). In this case, a command of restarting the storage-based remote copy from the management server 104A is issued at system administrator's timing when the host-based remote copy is restarted.

When a completion report is returned (step S609), the management server 104A sends an I/O restart request to the host 102A (step S610). The host 102A having received the I/O restart request turns the I/O pending flag 122A into OFF, and restarts the I/O processing (step S611). When the management server 104A receives an I/O restart report from the host 102A (step S612), the switchover processing from the host-based remote copy to the storage-based remote copy is completed.

When it becomes possible to restart the storage-based remote copy, the I/O pending flag 122A is turned into ON at step S602, and thereby the host 102A guarantees that the remote copy of either one method only is performed without fail to each I/O before and after the switchover of the remote copy method by changing the pair state into the suspended state at step S606, sending the I/O restart request at step S610, and turning the I/O pending flag 122A into OFF at step S611. Accordingly, it becomes possible to prevent a reversal in the order of writing by duplicate writing and an omission of writing to the storage 103B.

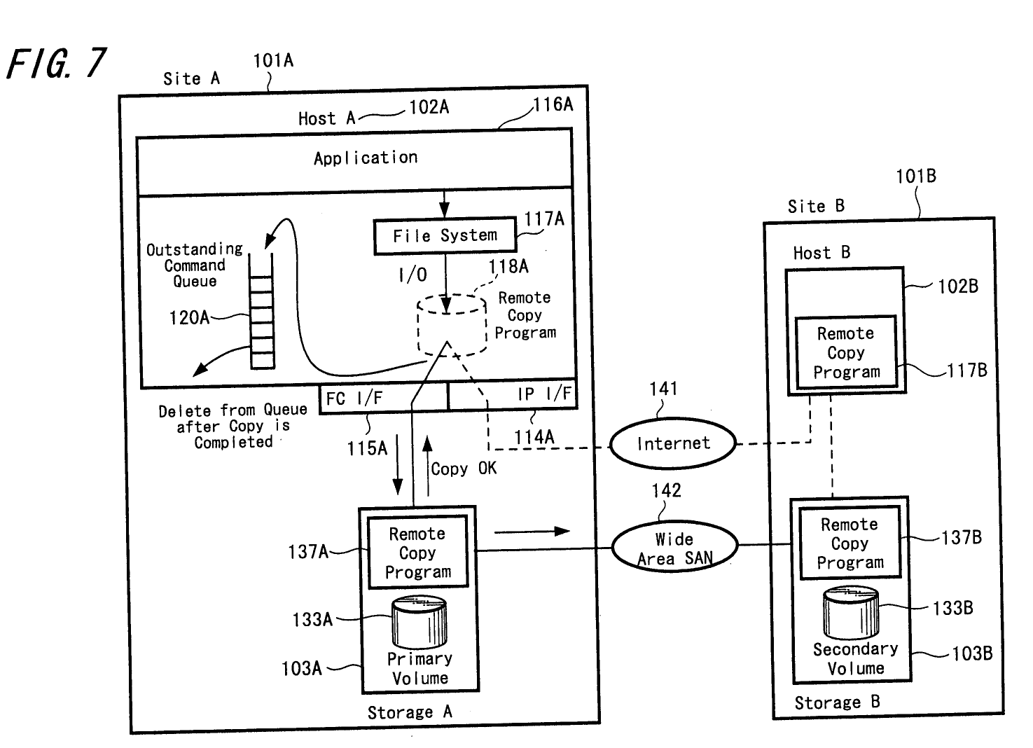

Next, an outline of the switchover procedure of remote copy method is explained by using FIGS. 7, 8, and 9.

FIG. 7 is a diagram showing an outline of the remote copy processing at normal time.

In the host 102A, a write I/O is issued to the storage 103A, and at the same time, contents of this I/O is retained in the outstanding command queue 120A. This retention of the I/O in the outstanding command queue 120A is executed by the file system 117A for making the remote copy program 118A perform the remote copy operation of the storage base to the processing command that is issued based on the application 116A.

The storage 103A performs the remote copy processing of the storage base between the storage 103A and the storage 103B, and reports a result thereof to the host 102A. The host 102A deletes the contents of the relevant I/O from the outstanding command queue 120A when the report of the successful copy is received.

In this case, the storage 103A or storage 103B has the remote copy program 137A or remote copy program 137B in order to perform the storage-based remote copy according to a command from the host 102A or host 102B, and thereby the contents of the primary volume 133A and the contents of the secondary volume 133B are made to match by mutually performing communication between the storage 103A and the storage 103B. It should be noted that the remote copy program 137B is used similarly when the storage-based remote copy is performed in accordance with a command from the host 102B.

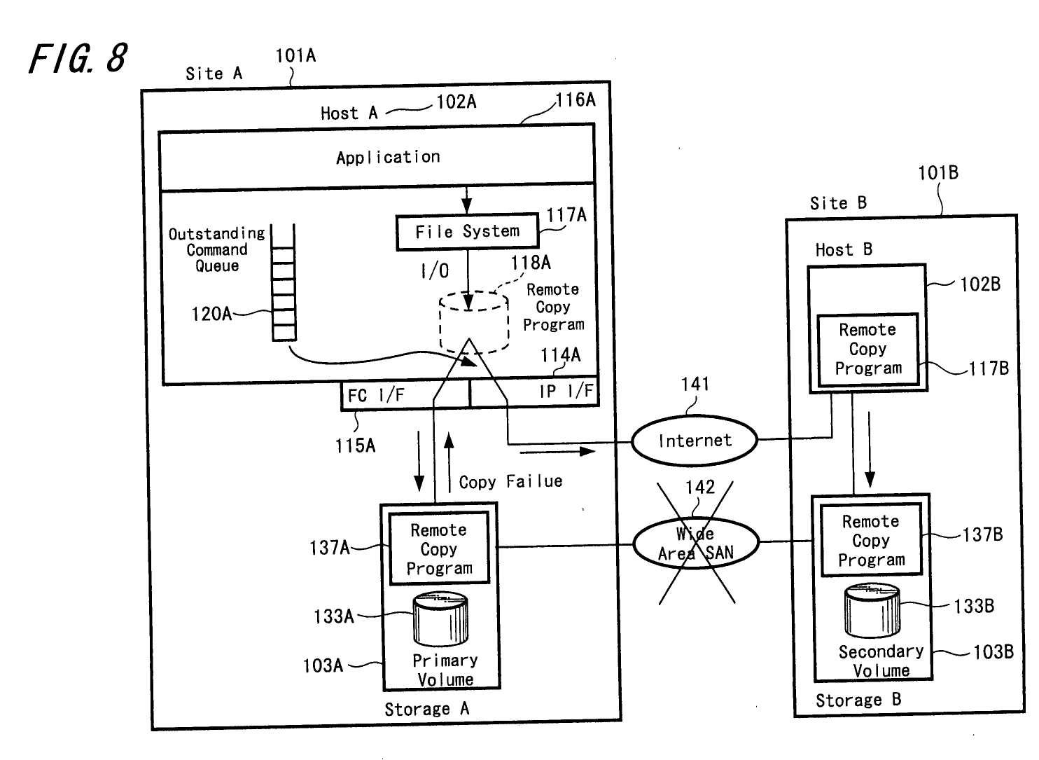

FIG. 8 is a diagram showing an outline of processing when a failure occurs in the storage-based remote copy. First, the storage 103A having started the storage-based remote copy reports to the host 102A that the storage-based remote copy is failed.

In this case, a detection of suspension in the storage-based remote copy is performed by detecting the suspension of the storage-based remote copy, wherein the storage 103A or storage 103B reports a result of the storage-based remote copy to the host 102A or host 102B for an I/O processing command issues to the storage 103A or storage 103B by the host 102A or host 102B, and the host 102A or host 102B having received the report checks the contents of the above-described report. The detection of suspension in the storage-based remote copy is similarly performed even when the storage-based remote copy is performed in accordance with a command from the host 102B.

The host 102A having received the report sends the contents of the outstanding command queue 120A, more specifically the unfinished I/O, to the host 102B. After receiving this I/O, the host 102B sends this I/O to the storage 103B. By the procedure described hereinbefore, the unfinished I/O is reflected on the secondary volume 133B. Thereby, the host-based remote copy is executed.

The host-based remote copy executed by the host 102A or host 102B is executed by the remote copy programs 118A and 118B for performing the host-based remote copy in which the contents of the primary volume 133A and the contents of the secondary volume 133B are made to match by mutually performing communication with the host 102A or host 102B, by the pair information 119A and 119B that show information on the primary volume 133A and the secondary volume 133B, and by the file systems 117A and 117B that make the remote copy programs 118A and 118B perform the remote copy operation to the processing command issued based on the application 116A. It should be noted that the remote copy program 118B, the pair information 119B, and the file system 117B are used similarly when the host-based remote copy is performed in accordance with a command from the host 102B.

The switchover of the remote copy method to the host-based remote copy which is executed by the host 102A or host 102B is executed when the host 102A or host 102B detects that the storage-based remote copy is suspended. This switchover of the remote copy method to the host-based remote copy is executed by the outstanding command queues 120A and 120B for storing the I/O processing command which has been issued from the host 102A or host 102B but has not been processed yet in the storage 103A or storage 103B, the pending command queues 121A and 121B for storing an I/O processing command to which the I/O processing is made pending in the storage 103A or storage 103B at the time of activating this remote copy, and the I/O pending flags 122A and 122B showing a state that the I/O processing is made pending in the storage 103A or storage 103B at the time of activating this host-based remote copy. It should be noted that the outstanding command queue 120B, the pending command queue 121B, the I/O pending flag 122B are used similarly when the switchover to the host-based remote copy is performed in accordance with a command from the host 102B.

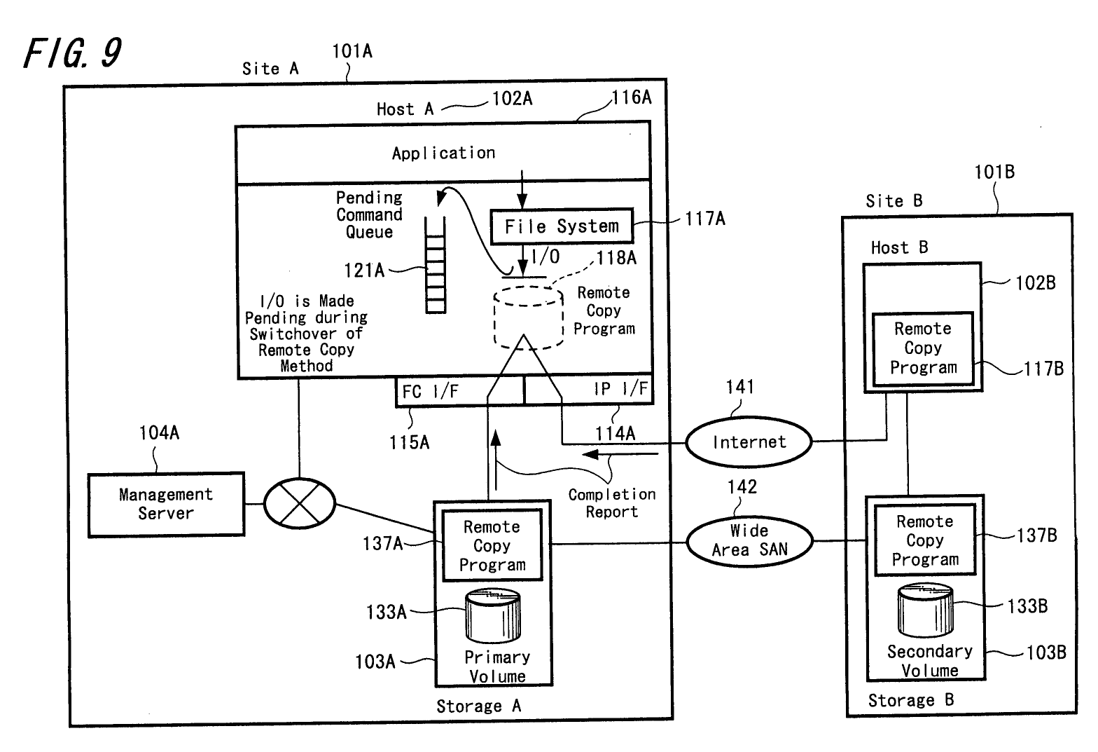

FIG. 9 is a diagram showing an outline of processing for restarting the storage-based remote copy.

The management server 104A sends a command of suspending the host-based remote copy and a command of restarting the storage-based remote copy to the host 102A and storage 103A, and switches over from the host-based remote copy to the storage-based remote copy. Since it is necessary to make an I/O pending during this switchover of the remote copy method, contents of the I/O are saved in the pending command queue 121A.

The processing for restarting the storage-based remote copy which is executed by the host 102A or host 102B is executed when the I/O processing performed to the storage 103A or storage 103B by the host-based remote copy is temporarily suspended. This processing for restarting the storage-based remote copy is performed by restarting the I/O processing that is performed to the storage 103A or storage 103B by the storage-based remote copy when a state of being able to restart the I/O processing is shown, wherein the I/O processing command which is stored in the pending command queues 121A and 121B and to which the I/O processing is made pending is executed by using the I/O pending flags 122A and 122B showing the state that the I/O processing is made pending in the storage 103A or storage 103B, and the pending command queues 121A and 121B for storing the I/O processing command to which the I/O processing is made pending in the storage 103A or storage 103B when the state that the I/O processing is made pending is shown by the I/O pending flags 122A and 122B. It should be noted that the pending command queue 121B and the I/O pending flag 122B are similarly used when the storage-based remote copy is restarted in accordance with a command from the host 102B.

There is a case in which a separate communication line is prepared between hosts even when the storage-based remote copy such as the one described hereinbefore is performed. In the patent reference 2, for example, the remote copy is performed by using the FC network connecting between storage apparatuses, and at the same time, hosts mutually monitor each other's state through the IP network connecting between the hosts.

Accordingly, it is possible to reduce costs in comparison with a case in which a communication line between storages is multiplexed, if such communication line between the hosts can be used as a path of the remote copy at the time of communication failure between the storages.

However, when only a remote copy method is simply switched over at the time of detecting a communication failure, there may occur such a case that the order of writing is reversed by duplicated writing and data is not written at the time of switchover.

Then, the host starts the host-based remote copy when the storage-based remote copy is failed. In that case, first the host starts from the copy to an unfinished I/O (to which the host has not received an response of having completed the remote copy from the storage apparatus although the host has issued the I/O).

When the storage-based remote copy is recovered, first the host stops issuing a new I/O, and waits for completion of processing of an outstanding I/O. Thereafter, I/O processing is restarted after the switchover of the remote copy method.

Thereby, it becomes possible to guarantee data consistency by controlling the order of remote copy and I/O processing at the time of switching over the remote copy method.

Next, another embodiment of the present invention is explained.

In another embodiment of the present invention explained hereinafter, a processing procedure of a remote copy program is different from the embodiment which has been already explained.

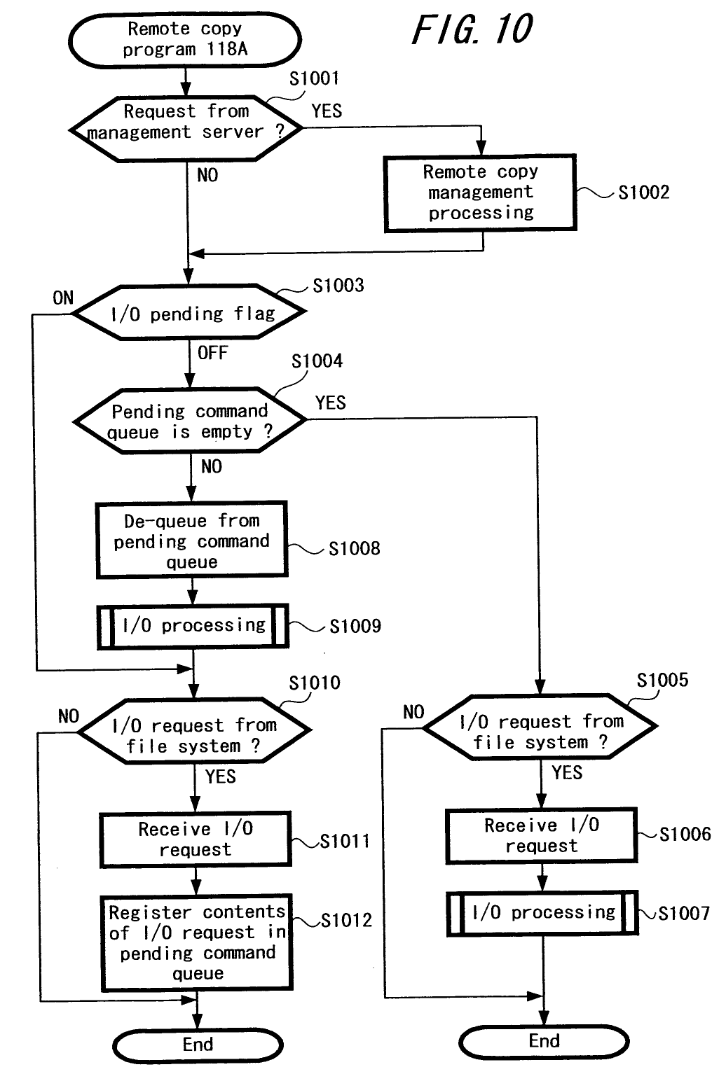

FIG. 10 is a flow chart showing a processing procedure of the remote copy program 118A in another embodiment.

Since processing in step S301 and step 302 in FIG. 10 is similar to those in the previous embodiment shown in FIG. 3, an explanation thereof is omitted.

Next, the CPU 111A checks an I/O pending flag (S1003), and proceeds to step S1010 if the I/O pending flag is ON. If the I/O pending flag is OFF, the CPU 111A checks whether a pending command queue is empty (S1004), and next checks whether or not there exists an I/O from a file system in case that the pending command queue is empty (S1005). If there exists the I/O, the CPU 111A receives that I/O (S1006), and performs I/O processing (S1007).

If the pending command queue is not empty in step S1004, the CPU 111A de-queues contents of the I/O from the pending command queue (S1008), and performs the I/O processing (S1009).

Next, the CPU 111A checks whether or not there exists an I/O from the file system (S1010). If there exists the I/O, the CPU 111A receives that I/O (S1011), and registers contents thereof in the pending command queue 121A (S1012).

If the I/O pending flag is ON in the steps from step S1003 to step S1012, the CPU 111A only retains the I/O in the pending command queue 121A, and does not perform the I/O processing. By this procedure, it becomes possible to make the I/O pending similarly to the processing in the steps from step S303 to step S309 of the previous embodiment described hereinbefore.

Here, in case of the previous embodiment, the CPU 111A has once stored the I/O in the pending command queue 121A at step S305 in order to simplify the flow of the processing even when the I/O is not pending, but in case of another embodiment, the pending command queue is not used other than the time that the I/O is pending. Due to this reason, processing overheads for queue operation can be reduced in case of another embodiment in comparison with the previous embodiment.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A computer system having at least a first host computer, a first storage apparatus that includes at least one first logical volume whose contents are read and written by said first host computer, a second host computer, and a second storage apparatus that includes at least one second logical volume whose contents are read and written by said second host computer, wherein the computer system is provided with:
a first remote copy function portion which is provided in said first storage apparatus or said second storage apparatus in order to perform a first remote copy in which the contents of said first logical volume and the contents of said second logical volume are made to match by performing communication mutually between said first storage apparatus and said second storage apparatus;
a second remote copy function portion which is provided in said first host computer or said second host computer in order to perform a second remote copy in which the contents of said first logical volume and the contents of said second logical volume are made to match by performing communication mutually between said first host computer and said second host computer;
a first remote copy suspension detection function portion which is provided in said first host computer or said second host computer in order for said first host computer or said second host computer to detect suspension of said first remote copy based on information from said first remote copy function portion; and
a second remote copy switchover function portion which is provided in said first host computer or said second host computer in order to switch over to said second remote copy performed by said second remote copy function portion and to activate said second remote copy when said first host computer or said second host computer detects the suspension of said first remote copy performed by said first remote copy function portion.

2. A computer system according to claim 1, wherein the second remote copy switchover function portion which is provided in said first host computer or said second host computer has a first temporary suspension function portion which temporarily suspends I/O processing performed to said first storage apparatus or said second storage apparatus by said second remote copy function portion, and a first remote copy restart function portion which restarts I/O processing performed to said first storage apparatus or said second storage apparatus by said first remote copy function portion.

3. A computer system according to claim 2, wherein the computer system is provided with either said first host computer and a first management computer which manages and controls an operation of said first storage apparatus or said second host computer and a second management computer which manages and controls an operation of said second storage apparatus, and
said first management computer or said second management computer has:
a temporary suspension command function portion which gives said first host computer or said second host computer a command to execute said temporary suspension by said first temporary suspension function portion prior to restart of said suspended first remote copy by said first remote copy function portion; and
a restart command function portion to give said first management computer or said second management computer a command to execute said first remote copy restart function by said first remote copy restart function portion after restart of said first remote copy by said first remote copy function portion.

4. A computer system according to claim 1, wherein said first storage apparatus or said second storage apparatus reports a result of said first remote copy to said first host computer or said second host computer for an I/O processing command which is issued to said first storage apparatus or said second storage apparatus by said first host computer or said second host computer, said first host computer or said second computer having received the report checks contents of said report, and thereby said first remote copy suspension detection function portion detects suspension of said first remote copy.

5. A computer system according to claim 1, wherein said first remote copy function portion which is provided in said first storage apparatus or said second storage apparatus is executed by a remote copy program to perform said first remote copy in which the contents of said first logical volume and the contents of said second logical volume are made to match by performing the communication mutually between said first storage apparatus and said second storage apparatus, pair information showing information as to said first logical volume and said second logical volume, and an I/O processing control program to perform an operation for the I/O processing command issued from said first host computer or said second host computer.

6. A computer system according to claim 1, wherein said second remote copy function portion which is provided in said first host computer or said second host computer is executed by a remote copy program to perform said second remote copy in which the contents of said first logical volume and the contents of said second logical volume are made to match by performing the communication mutually between said first host computer and said second host computer, pair information showing information as to said first logical volume and said second logical volume, and a file system to make said remote copy program perform a remote copy operation for a processing command which is issued based on an application.

7. A computer system according to claim 1, wherein said second remote copy switchover function portion which is provided in said first host computer or said second host computer is executed by:
an outstanding command queue to store the I/O processing command which has been issued from said first host computer or said second host computer but has not been processed yet in said first storage apparatus or said second storage apparatus when said first host computer or said second host computer detects that said first remote copy performed by said first remote copy function portion is suspended;
a pending command queue to store the I/O processing command to which the I/O processing is made pending in said first storage apparatus or said second storage apparatus at the time of switchover to and activation of said second remote copy by said second remote copy function portion; and
an I/O processing pending flag to show a state that the I/O processing is made pending in said first storage apparatus or said second storage apparatus at the time of activating said second remote copy after switching over to said second remote copy by said second remote copy function portion.

8. A computer system according to claim 2, wherein said first remote copy restart function portion which is provided in said first host computer or said second host computer has:
an I/O processing pending flag to show a state that the I/O processing is made pending in said first storage apparatus or said second storage apparatus when said first temporary suspension function portion suspends temporarily the I/O processing performed to said first storage apparatus or said second storage apparatus by said second remote copy function portion; and
a pending command queue to store an I/O processing command to which the I/O processing is made pending in said first storage apparatus or said second storage apparatus when a state of having pending I/O processing is shown by said I/O processing pending flag, and
when a state of being able to restart the I/O processing is shown by said I/O processing pending flag, the I/O processing performed to said first storage apparatus or said second storage apparatus by said first remote copy function portion is restarted by executing the I/O processing command which is stored in said pending command queue and to which the I/O processing is made pending.

9. A remote copy processing method in a computer system which has at least a first host computer, a first storage apparatus that includes at least one first logical volume whose contents are read and written by said first host computer, a second host computer, and a second storage apparatus that includes at least one second logical volume whose contents are read and written by said second host computer, wherein the remote copy processing method is provided with:
a first remote copy step of making the contents of said first logical volume and the contents of said second logical volume matched by performing communication mutually between said first storage apparatus and said second storage apparatus;
a first remote copy suspension detection step in which said first host computer or said second host computer detects suspension of said first remote copy based on information in said first remote copy step;
a remote copy switchover step of switching over to the other remote copy and activating the other remote copy when said first host computer or said second host computer detects, in said first remote copy suspension detection step, the suspension of the first remote copy based on the information in said first remote copy step; and
a second remote copy step of performing a second remote copy in which the contents of said first logical volume and the contents of said second logical volume are made to match by performing communication mutually between said first host computer and said second host computer at the time of switching over to the other remote copy and activating the other remote copy in said remote copy switchover step.

10. A remote copy processing method according to claim 9, wherein said remote copy switchover step has a first temporary suspension step of suspending temporarily I/O processing performed to said first storage apparatus or said second storage apparatus by said second remote copy step, and a first remote copy restart step of restarting I/O processing performed to said first storage apparatus or said second storage apparatus by said first remote copy step.

11. A remote copy processing method according to claim 10, wherein a first management computer which manages and controls operations of said first host computer and said first storage apparatus, or a second management computer which manages and controls operations of said second host computer and said second storage apparatus executes:
a temporary suspension command step of giving said first host computer or said second host computer a command to execute said temporary suspension by said first temporary suspension step prior to restart of said suspended first remote copy by said first remote copy step; and
a restart command step of giving said first host computer or said second host computer a command to execute a restart function of said first remote copy by said first remote copy restart step after the restart of said first remote copy by said first remote copy step.

12. A remote copy processing method according to claim 9, wherein said first remote copy suspension detection step detects the suspension of said first remote copy by a process in which said first storage apparatus or said second storage apparatus reports a result of said first remote copy to said firs host computer or said second host computer for an I/O processing command issued to said first storage apparatus or said second storage apparatus by said first host computer or said second host computer, and said first host computer or said second host computer having received the report checks contents of said report.

13. A remote copy processing method according to claim 9, wherein said first remote copy step which is executed by said first storage apparatus or said second storage apparatus is executed by a remote copy program to perform said first remote copy in which the contents of said first logical volume and the contents of said second logical volume are made to match by performing the communication mutually between said first storage apparatus and said second storage apparatus, pair information that shows information as to said first logical volume and said second logical volume, and an I/O processing control program to perform an operation for the I/O processing command that is issued from said first host computer or said second host computer.

14. A remote copy processing method according to claim 9, wherein said second remote copy step which is executed by said first host computer or said second host computer is executed by a remote copy program to perform said second remote copy in which the contents of said first logical volume and the contents of said second logical volume are made to match by performing the communication mutually between said first host computer and said second host computer, pair information showing information as to said first logical volume and said second logical volume, and a file system to make said remote copy program perform a remote copy operation for a processing command that is issued based on an application.

15. A remote copy processing method according to claim 9, wherein said remote copy switchover step that is executed by said first host computer or said second host computer is executed by:
an outstanding command queue to store an I/O processing command which has been issued from said first host computer or said second host computer but has not been processed in said first storage apparatus or said second storage apparatus when said first host computer or said second host computer detects the suspension of said first remote copy by said first remote copy step;
a pending command queue to store an I/O processing command to which I/O processing is made pending in said first storage apparatus or said second storage apparatus at the time of switchover to and activation of said second remote copy by said second remote copy step; and
an I/O processing pending flag to show a state that the I/O processing is made pending in said first storage apparatus or said second storage apparatus at the time of switchover to and activation of said second remote copy by said second remote copy step.

16. A remote copy processing method according to claim 10, wherein said first remote copy restart step which is executed by said first host computer or said second host computer has:
an I/O processing pending flag to show a state that the I/O processing is made pending in said first storage apparatus or said second storage apparatus when said first temporary suspension step suspends temporarily the I/O processing performed to said first storage apparatus or said second storage apparatus by said second remote copy step; and
a pending command queue to store an I/O processing command to which the I/O processing is made pending in said first storage apparatus or said second storage apparatus when a state that the I/O processing is made pending is shown by said I/O processing pending flag, and
when a state of being able to restart the I/O processing is shown by said I/O processing pending flag, the I/O processing performed to said first storage apparatus or said second storage apparatus by said first remote copy step is restarted by executing the I/O processing command which is stored in said pending command queue and to which the I/O processing is made pending.
